(19) United States
(12) Patent Application Publication
(10) Pub. No.: US 2026/0061608 A1
(43) Pub. Date: Mar. 5, 2026

(54) ROBOT AND CONTROL METHOD THEREOF

(71) Applicant: SAMSUNG ELECTRONICS CO., LTD., Suwon-si (KR)

(72) Inventors: Sangyoung HWANG, Suwon-si (KR); Boseok Moon, Suwon-si (KR); Sanghyun Bae, Suwon-si (KR); Dongshin Song, Suwon-si (KR)

(73) Assignee: SAMSUNG ELECTRONICS CO., LTD., Suwon-si (KR)

(21) Appl. No.: 19/259,916

(22) Filed: Jul. 3, 2025

Related U.S. Application Data
(63) Continuation of application No. PCT/KR2025/007710, filed on Jun. 5, 2025.

(30) Foreign Application Priority Data
Sep. 3, 2024 (KR) 10-2024-0119174

(51) Int. Cl. B25J 9/16

(52) U.S. Cl. CPC B25J 9/1653

(57) ABSTRACT

A robot includes: memory storing instructions; and one or more processors including processing circuitry, wherein the instructions, when executed by the one or more processors individually or collectively, cause the robot to: monitor at least one function of the robot, wherein the at least one function is associated with performing a predetermined task; based on identifying that an error related to the at least one function has occurred, identify a type of the error; identify a degree to which the robot is able to perform the predetermined task after occurrence of the error, based on the type of the error; and modify the at least one function based on the degree to which the robot is able to perform the predetermined task.

### CROSS-REFERENCE TO RELATED APPLICATIONS

This application is a by-pass continuation of International Application No. PCT/KR2025/007710, filed on June 5, 2025, which is based on and claims priority to Korean Patent Application No. 10-2024-0119174, filed in the Korean Intellectual Property Office on September 03, 2024, the disclosures of which are incorporated herein by reference in their entireties.

### BACKGROUND

### 1. Field

The disclosure relates to a robot and a control method thereof, and more particularly to, a robot providing a safety function and a control method thereof.

### 2. Description of Related Art

In recent years, advancements in the technologies for robots securing a higher-level safety function have been made as research into robots integrated with an AI technology has been performed.

Robots may have a safety function of stopping a function of the robot immediately to prevent an accident caused by the occurrence of an error in a function of the robot. However, such a safety function results in a limitation of the efficiency and productivity in performance of a task, raising a problem regarding the safety function.

### SUMMARY

According to an aspect of the disclosure, a robot includes: memory storing instructions; and one or more processors including processing circuitry, wherein the instructions, when executed by the one or more processors individually or collectively, cause the robot to: monitor at least one function of the robot, wherein the at least one function is associated with performing a predetermined task; based on identifying that an error related to the at least one function has occurred, identify a type of the error; identify a degree to which the robot is able to perform the predetermined task after occurrence of the error, based on the type of the error; and modify the at least one function based on the degree to which the robot is able to perform the predetermined task.

The memory may further store score information corresponding a type of an error related to each of a plurality of tasks including the predetermined task, and the instructions, when executed by the one or more processors individually or collectively, may further cause the robot to: identify a score corresponding to the degree to which the robot is able to perform the predetermined task based on the score information; and modify the at least one function based on the score.

The robot may further include: at least one sensor, wherein the instructions, when executed by the one or more processors individually or collectively, may further cause the robot to: obtain context information on a task environment of the robot based on sensing data obtained from the at least one sensor; and modify the at least one function based on the context information and the degree to which the robot is able to perform the predetermined task.

The memory further stores first score information corresponding to a type of an error related to each of a plurality of tasks including the predetermined task and second score information related to each of a plurality of task environments, and the instructions, when executed by the one or more processors individually or collectively, may further cause the robot to: identify, based on the first and the second score information, a first score corresponding to the degree to which the robot is able to perform the predetermined task; identify, based on the first and the second score information, a second score corresponding to the context information; and modify the at least one function based on the first score and the second score.

The instructions, when executed by the one or more processors individually or collectively, may further cause the robot to: identify one of a plurality of control levels corresponding to the at least one function based on the first score and the second score; and modify the at least one function based on the identified control level.

The plurality of control levels includes at least one of function maintenance, limited function maintenance, function stop after completion of a current task, and immediate function stop.

The instructions, when executed by the one or more processors individually or collectively, may further cause the robot to provide an alarm notification corresponding to the identified control level.

The instructions, when executed by the one or more processors individually or collectively, may further cause the robot to: identify a weight to be applied to each of the first score and the second score based on a number of types of the context information; and modify the at least one function based on the first score and the second score to which the identified weight is applied.

The instructions, when executed by the one or more processors individually or collectively, may further cause the robot to: identify, based on a type of the error, second sensing data to substitute for first sensing data of a sensor to which the error occurs among the at least one sensor; and identify the degree to which the robot is able to perform the predetermined task by substituting the first sensing data with the second sensing data.

The robot may further include: at least one sensor, wherein the instructions, when executed by the one or more processors individually or collectively, may further cause the robot to: identify one of a plurality of control levels corresponding to the at least one function by inputting, to an artificial intelligence model, type information of the error and sensing data obtained from the at least one sensor; and modify the at least one function based on the identified control level.

According to an aspect of the disclosure, a method of controlling a robot, includes: monitoring at least one function of the robot, wherein the at least one function is associated with performing a predetermined task; based on identifying that an error related to the at least one function has occurred, identifying a type of the error; identifying a degree to which the robot is able to perform the predetermined task after occurrence of the error, based on the type of the error; and modifying the at least one function based on the degree to which the robot is able to perform the predetermined task.

The modifying the at least one function may include: identifying a score corresponding to the degree to which the robot is able to perform the predetermined task based on score information corresponding to a type of an error related to each of a plurality of tasks including the predetermined task; and modifying the at least one function based on the score.

The modifying the at least one function includes: obtaining context information on a task environment of the robot based on sensing data obtained from at least one sensor of the robot; and modifying the at least one function based on the context information and the degree to which the robot is able to perform the predetermined task.

The modifying the at least one function further includes: identifying, based on score information corresponding to a type of an error related to each of a plurality of tasks including the predetermined task, a first score corresponding to the degree to which the robot is able to perform the predetermined task; identifying, based on score information of each of a plurality of task environments, a second score corresponding to the context information; and modifying the at least one function based on the first score and the second score.

The modifying the at least one function further includes: identifying one of a plurality of control levels corresponding to the at least one function based on the first score and the second score; and modifying the at least one function based on the identified control level.

According to an aspect of the disclosure, a non-transitory computer readable storage medium having instructions stored therein, which when executed by one or more processors cause the one or more processors to execute a method of controlling a robot, the method including: monitoring at least one function of the robot, wherein the at least one function is associated with performing a predetermined task; based on identifying that an error related to the at least one function has occurred, identifying a type of the error; identifying a degree to which the robot is able to perform the predetermined task after occurrence of the error, based on the type of the error; and modifying the at least one function based on the degree to which the robot is able to perform the predetermined task.

The modifying the at least one function may include: identifying a score corresponding to the degree to which the robot is able to perform the predetermined task based on score information corresponding to a type of an error related to each of a plurality of tasks including the predetermined task; and modifying the at least one function based on the score.

The modifying the at least one function may include: obtaining context information on a task environment of the robot based on sensing data obtained from at least one sensor of the robot; and modifying the at least one function based on the context information and the degree to which the robot is able to perform the predetermined task.

The modifying the at least one function may further include: identifying, based on score information corresponding to a type of an error related to each of a plurality of tasks including the predetermined task, a first score corresponding to the degree to which the robot is able to perform the predetermined task; identifying, based on score information of each of a plurality of task environments, a second score corresponding to the context information; and modifying the at least one function based on the first score and the second score.

The modifying the at least one function may further include: identifying one of a plurality of control levels corresponding to the at least one function based on the first score and the second score; and modifying the at least one function based on the identified control level.

### BRIEF DESCRIPTION OF THE DRAWINGS

The above and other aspects and features of certain embodiments of the present disclosure will be more apparent from the following description taken in conjunction with the accompanying drawings, in which:

FIG. 1 is a view provided to explain an operation of a robot, according to one or more embodiments;

FIG. 2 is a block diagram provided to explain a configuration of a robot, according to one or more embodiments;

FIG. 3 is a block diagram provided to explain a detailed configuration of a robot, according to one or more embodiments;

FIG. 4 is a view provided to explain a process of identifying score information corresponding to a type of an error of each predetermined task of a robot, according to one or more embodiments;

FIG. 5 is a view provided to explain a process of identifying a score corresponding to a performable degree of a predetermined task of a robot, according to one or more embodiments;

FIG. 6 is a view provided to explain a process of identifying a score corresponding to context information on a task environment of a robot, according to one or more embodiments;

FIG. 7 is a view provided to explain a process of identifying a plurality of control levels corresponding to at least one function of a robot, according to one or more embodiments;

FIG. 8 is a view provided to explain a process of identifying a first score and a second score based on weighted scores, according to one or more embodiments;

FIG. 9 is a view provided to explain a process of identifying a performable degree of a predetermined task based on alternative data of a robot, according to one or more embodiments;

FIG. 10 is a view provided to explain a process of controlling at least one function based on an artificial intelligence model of a robot, according to one or more embodiments;

FIG. 11 is a view provided to explain a process of controlling at least one function of a robot, according to one or more embodiments;

FIG. 12 is a flowchart provided to explain an entire operation process of a robot, according to one or more embodiments; and

FIG. 13 is a flowchart provided to explain an operation of a robot, according to one or more embodiments.

### DETAILED DESCRIPTION

General terms currently widely used are selected as the terms used in the embodiments of the disclosure in consideration of their functions in the disclosure, but may be changed based on the intention of those skilled in the art or a judicial precedent, the emergence of a new technology, or the like. In addition, in a specific case, terms arbitrarily chosen by the applicant may be included in the terms used herein. In this case, the meanings of such terms are provided in detail in the corresponding descriptions of the disclosure. Therefore, the terms used in the embodiments of the disclosure are to be defined on the basis of meanings thereof and overall details throughout the disclosure rather than simply names thereof.

In the disclosure, the expression “have”, “may have”, “include”, “may include” or the like, indicates the existence of a corresponding feature (e.g., a numerical value, a function, an operation or an element such as a part), and does not exclude the existence of an additional feature.

As used herein, the expression “at least one of a, b and c” indicates “only a,” “only b,” “only c,” “both a and b,” “both a and c,” “both b and c,” or “all of a, b, and c.”

The expression “1st”, “2nd”, “first”, “second”, or the like, used in the disclosure, may be used to refer to various elements regardless of their order and/or importance, and may be used merely to differentiate one element from another but not be intended to limit the elements.

Based on one element (e.g., a first element) referred to as being “(operatively or communicatively) coupled with/to” or “connected with/to” another element (e.g., a second element), it is to be understood that one element may be connected to another element directly, or through yet another element (e.g., a third element).

In the disclosure, singular forms include plural forms as well, unless explicitly indicated otherwise. In the disclosure, the term “include” or “composed of” and the like means the presence of stated features, integers, steps, operations, elements, components or combinations thereof but do not imply the exclusion of the presence or addition of one or more other features, integers, steps, operations, elements, components or combinations thereof.

In the disclosure, the term “module” or “unit” may perform at least one function or operation, and be implemented by hardware or software or by a combination of hardware and software. Additionally, a plurality of “modules” or a plurality of “units” may be integrated into at least one module and be implemented by at least one processor except for a “module” or a “unit” that needs to be implemented by specific hardware.

With regard to any method or process described herein, an identification code may be used for the convenience of the description but is not intended to illustrate the order of each step or operation. Each step or operation may be implemented in an order different from the illustrated order unless the context clearly indicates otherwise. One or more steps or operations may be omitted unless the context of the disclosure clearly indicates otherwise.

The various actions, acts, blocks, steps, or the like in the flow diagrams may be performed in the order presented, in a different order, or simultaneously. Further, in one or more embodiments, some of the actions, acts, blocks, steps, or the like may be omitted, added, modified, skipped, or the like without departing from the scope of the disclosure.

In the disclosure, the term “user” may refer to a person who uses an electronic apparatus or an electronic apparatus used by the person.

Hereinafter, one or more embodiments of the present disclosure are described specifically with reference to the accompanying drawings.

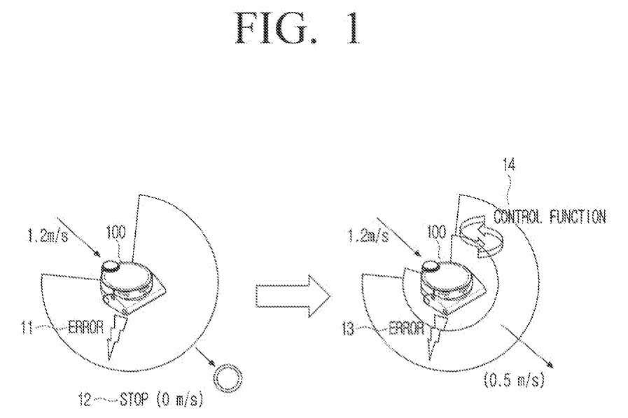

FIG. 1 is a view provided to explain an operation of a robot, according to one or more embodiments.

A robot 100 may be an apparatus that can travel in a state where the robot 100 is not driven directly by a human. The robot 100 may be referred to as an autonomous mobile apparatus, an autonomous mobile robot (AMR), an automated guided vehicle (AGV), an unmanned ground vehicle (UGV) and the like in various ways, but is collectively referred to as a robot 100 for purposes of the present disclosure.

The robot 100 may be implemented as various types of robots and the like such as a cleaning robot, a serving robot, a movable projector, an industrial robot, a guide robot, a delivery robot and the like that perform a required task while traveling in a space, based on a method of use or usage thereof.

The robot 100 may include at least one of various types of sensors such as a LiDAR sensor, an infrared sensor, an image sensor, an ultrasonic sensor, a depth camera and the like. The robot 100 may implement at least one function for performing a predetermined task though the above-described sensors.

The predetermined task may include various types of tasks such as a cleaning task, a serving task, an industrial task, an education and research task, a medical task and the like. In one example, the robot 100 may be a robot designed or manufactured to perform a predetermined task. In one example, as for the robot 100, at least one function implementable according to a predetermined task may differ.

According to one or more embodiments, the robot 100 may identify whether an error (e.g., a failure) in relation to at least one function occurs. The robot 100 may identify whether an error in relation to at least one function occurs through a data analysis based on sensing data, a self-diagnosis algorithm, log monitoring, an external system alarm notification and the like. For example, in the case where a sensing value corresponding to a certain direction and angle is not identified through a sensor, the robot 100 may identify that an error occurs in a sensing function. For example, in a case where an input travel speed differs from a travel speed identified from an encoder, the robot may identify that an error occurs in a travel function.

According to one or more embodiments, when identifying that an error occurs in the at least one function, the robot 100 may control the at least one function based on the degree to which the robot 100 is capable of performing the task despite the occurrence of the error (also referred to herein as “a performable degree of a predetermined task”). For example, the robot 100 may modify the at least one function based on the degree to which the robot 100 is capable of performing the predetermined task. Put another way, to prevent deterioration in task performance as much as possible despite the occurrence of an error in a certain function, the modify the function in which the error occurs based on the degree to which the robot 100 remains capable of performing the task.

In one example, despite the occurrence of an error in at least one function, in a case where a predetermined task is performable through the other functions except for the function in which the error occurs, the robot 100 may control the at least one function step by step.

In one example, despite the occurrence of an error in at least one function, in a case where a predetermined task is performable through the function in which the error occurs, the robot 100 may control the at least one function step by step.

In one example, in a case where the predetermined task is not performable due to an error occurring in the at least one function, the robot 100 may stop all functions or the at least one function immediately.

The occurrence of an error in a function may include a situation in which a corresponding function is not performable normally and/or efficiently, such as when an abnormality occurs to the system, software, and hardware configuration of the robot 100. For example, in a case where an error occurs to a travel motor of the robot 100, the robot 100 may be unable to perform a travel function or may able to perform the travel function, but may only be able to perform the travel function inefficiently or in a limited manner, depending on an error level. For example, the occurrence of an error in at least one function of the robot 100 may include a case in which a predetermined task is performable but causes greater time consumption and greater power consumption than in the case where the error does not occur, as well as a case in which the predetermined task is not performable due to the error.

According to one or more embodiments, the robot 100 may identify a type of an error in relation to at least one function among a plurality error types, and based on the type of the error, identify a performable degree of a predetermined task.

Referring to FIG. 1, the robot 100 may identify an error occurring in at least one function among a plurality of functions for performing a predetermined task. The robot 100 may identify the robot’s 100 performable degree of the predetermined task based on the error having occurred. In the case where an error 11 occurs in at least one function to the degree that a task is not performable, the robot 100 may stop 12 all functions immediately. On the other hand, the robot 100 may control 14 at least one function in the case where a predetermined task is performable although an error 13 occurs in the at least one function.

For example, in a case where the robot 100 is traveling at 1.2 m/s and an error 11 occurs in at least one function such as a sensing function, an object detecting function, or the like to the degree that a predetermined task is not performable, the robot 100 may stop all functions, or the at least one function, immediately. For example, in the case where a predetermined task is performable through the other functions except for a function in which an error 13 occurs, despite the error 13 occurring in at least one function of the robot 100 traveling at 1.2 m/s, the robot 100 may control 14 the at least one function by reducing the travel speed (travel speed 0.5 m/s) and the like depending on a performable degree of the predetermined task.

Hereinafter, one or more embodiments of identifying a performable degree of a predetermined task based on a type of an error and controlling at least one function by the robot 100 are described with reference to the drawings.

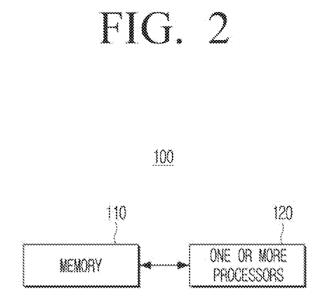

FIG. 2 is a block diagram provided to explain a configuration of a robot, according to one or more embodiments.

Referring to FIG. 2, a robot 100 includes memory 110 and one or more processors 120. However, the configuration of the robot 100 may not be limited thereto, and the robot 100 may be implemented in the way that part of the elements are excluded or another element is further included.

The memory 110 may store at least one instruction, datum, program and the like required for an operation of the robot 100. In one example, the memory 110 may store score information corresponding to a type of an error of each task.

The memory 110 may be implemented in the form of memory embedded in the robot 100 or in the form of memory detachable from the robot 100 depending on a data storage purpose. In one example, in the case of data for driving the robot 100, the data may be stored in the memory embedded in the robot 100, and in the case of data for an expansion function of the robot 100, the data may be stored in memory detachable from the robot 100.

The memory embedded in the robot 100 may be implemented in the form of at least one of volatile memory (e.g., dynamic RAM (DRAM), static RAM (SRAM) or synchronous dynamic RAM (SDRAM), and the like), or non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., NAND flash or NOR flash, and the like), hard drive, and solid state drive (SSD)).

The memory 110 may be implemented in the form of single memory storing data generated in various operations according to the disclosure, but embodiments of the disclosure are not limited thereto, and the memory 110 may be implemented to include a plurality of memories storing different types of data respectively or storing data generated in different operations respectively.

The one or more processors 120 control operations of the robot 100 entirely. Specifically, the one or more processors 120 may control the operations of the robot 100 entirely by being connected with each element of the robot 100. For example, the one or more processors 120 may control the entire operations of the robot 100 by being connected with the memory 110 electrically. The one or more processors 120 may include processing circuitry, and be composed of one processor or a plurality of processors.

The one or more processors 120 may perform the operations of the robot 100 according to one or more embodiments, by individually or collectively executing one or more instructions stored in the memory 110.

The one or more processors 120 may include one or more of a central processing unit (CPU), a graphics processing unit (GPU), an accelerated processing unit (APU), a Many Integrated Core (MIC), a digital signal processor (DSP), a neural processing unit (NPU), a hardware accelerator, or a machine learning accelerator. The one or more processors 120 may control one or any combination of the other elements of the robot, and perform an operation in relation to communications or data processing. The one or more processors 120 may execute one or more programs or instructions stored in the memory. For example, the one or more processors may perform a method according to one or more embodiments by executing the one or more instructions stored in the memory.

In the case where a method according to one or more embodiments includes a plurality of operations, the plurality of operations may be performed by one processor or a plurality of processors. For example, at a time when a first operation, a second operation, and a third operation are performed based on the method according to one or more embodiments, the first operation, the second operation and the third operation may all be performed by a first processor, or while the first operation and the second operation may be performed by a first processor (e.g., a general purpose processor), the third operation may be performed by a second processor (e.g., an artificial intelligence-exclusive processor).

The one or more processors 120 may be implemented as a single-core processor including one core, or one or more multi-core processors including a plurality of cores (e.g., a homogeneous multi core or a heterogeneous multi core). In the case where the one or more processors 120 are implemented as a multi-core processor, each of a plurality of cores included in the multi-core processor may include internal processor memory such as cache memory, and/or on-chip memory, and a common cache shared by the plurality of cores may be included in the multi-core processor. Additionally, each of the plurality of cores (or part of the plurality of cores) included in the multi-core processor may independently perform the method according to one or more embodiments by reading a program instruction for implementing the method, or all (or part) of the plurality of cores may be associated and perform the method according to one or more embodiments by reading a program instruction for implementing the method.

In the case where a method according to one or more embodiments includes a plurality of operations, the plurality of operations may be executed by one of the plurality of cores included in the multi-core processor or by the plurality of cores. For example, at a time when a first operation, a second operation, and a third operation are performed based on the method according to one or more embodiments, the first operation, the second operation and the third operation may all be performed by a first core included in the multi-core processor, or while the first operation and the second operation may be performed by a first core included in the multi-core processor, the third operation may be performed by a second core included in the multi-core processor.

In the embodiments of the disclosure, the processor may denote a system on a chip (SoC) where one or more processors and other electronic components are integrated, a single-core processor, a multi-core processor, or a core included in a single-core processor or a multi-core processor, and herein, the core may be implemented as a CPU, GPU, APU, MIC, DSP, NPU, a hardware accelerator or a machine learning accelerator and the like, but the embodiments of the disclosure are not limited thereto. Hereinafter, one or more processors 120 are referred to as a processor 120 for convenience of description.

According to one example, the processor 120 may monitor in real time at least one function of the robot 100 for performing a predetermined task. The operation of monitoring may be a process of continuously tracking and evaluating whether a function of the robot 100 is performed as pre-defined (or pre-intended). According to one or more embodiments, the processor 120 may perform function monitoring through log data monitoring, metric data monitoring, sensing data monitoring, notification information monitoring, automation test monitoring and the like.

For example, the processor 120 may monitor, in real time, whether a sensing value is sensed by at least one sensor as pre-intended. For example, the processor 120 may monitor, in real time, whether a sensing value is output through an internal algorithm as pre-intended and/or whether there isn’t any error in the output sensing value.

The at least one function may include a plurality of types of functions such as a moving function, a sensing function, a map-generating function, a task-performing function, a learning function and the like. For example, in the case of a serving robot, the at least function may include a plurality of functions such as a moving function for serving, a loading function for serving loaded objects, a spatial map-generating function for generating a travel map, and the like.

According to one or more embodiments, when identifying that an error occurs in at least one function, the processor 120 may identify a type of the error.

According to one example, an error in a function may be categorized into a plurality error types. In one example, the errors may be categorized as an input error type, a process error type and an output error type. For example, the input error type may be categorized specifically as a sensor error type, a timing error type, a self-test error type and the like. For example, the process error type may be categorized specifically as an algorithm error type, a memory error type, and the like. For example, the output error type may be categorized specifically as an actuator error type, a feedback error type and the like.

For example, the plurality of error types may be divided and defined previously based on each function, and in a case where an error in a function occurs, the processor 120 may identify one of error types mapped in the function. However, the error types are not limited thereto, and regardless of the function, the plurality of error types may be defined previously, and in a case where an error in a function occurs, the processor 120 may identify one of the plurality of error types. Hereinafter, identifying one of the plurality of error types by the processor 120, in a case where an error in a function occurs, is described.

According to one or more embodiments, the processor 120 may identify a performable degree of a predetermined task, in view of the occurrence of an error, based on a type of the error. The performable degree of the predetermined task may be numerical data for determining how much (or to what degree) the identified error type affects performance of the task.

According to one or more embodiments, the processor 120 may control at least one function based on a performable degree of a predetermined task. The processor 120 may modify the at least one function based on at least one of a plurality of control levels based on the performable degree of the predetermined task.

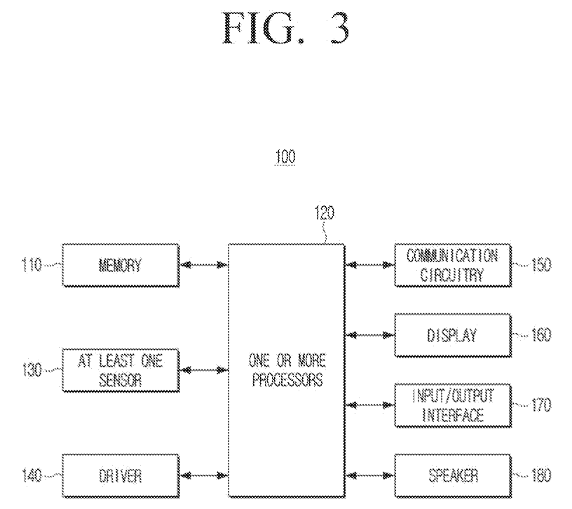

FIG. 3 is a block diagram provided to explain a detailed configuration of a robot, according to one or more embodiments.

According to FIG. 3, a robot 100 includes memory 110, one or more processors 120, at least one sensor 130, a driver 140, communication circuitry 150, a display 160, an input/output interface 170 and a speaker 180. Among the elements illustrated in FIG. 3, elements identical with the elements illustrated in FIG. 2 are not described in detail.

The at least one sensor 130 is a sensor for sensing a surrounding environment and obtaining context information on a task environment. Specifically, the at least one sensor 130 may include one or more of a LiDAR sensor, a vision sensor, an image sensor, an infrared sensor, an ultrasonic sensor, a gyro sensor, an acceleration sensor or a proximity sensor. Additionally, the at least one sensor 130 may include one or more of a 2D camera, a ToF (Time of Flight) camera, a depth camera, a multi-lens arranged camera, a stereo vision system, a fused LiDAR camera, or a 3D camera.

The driver 140 is an element for moving a main body of the robot 100. The driver 140 may include elements such as a plurality of wheels, a driving motor for rotating each of the plurality of wheels, a gear, a shaft and the like. The plurality of wheels is provided at the lower side or on the lateral surface of the main body of the robot 100, and supports the main body of the robot 100 from a bottom surface. As the driving motor operates and driving force thereof is delivered to the plurality of wheels, each of the wheels may be rotated, such that the robot 100 may be moved by a frictional force between the bottom surface and the wheel. In addition, the driver 140 may make a rotation speed of at least one of the plurality of wheels different, or adjust an alignment direction of the wheels differently, at a time when a direction is changed. Instead of the wheels, a continuous track and the like may be used depending on the sort of a robot 100 or the weight of a loaded item or an environment where a robot 100 is used.

The communication circuitry 150 may include various standards of a wired or wireless input/output interface (or an input/output terminal). The communication circuitry 150 may be an element that performs communication with various types of external apparatuses based on various types of communication methods. The communication circuitry 150 may include a wireless communication module or a wired communication module. Herein, each communication module may be implemented in the form of at least one hardware chip.

The communication circuitry 150 may include various types of interfaces such as High Definition Multimedia Interface (HDMI) , Mobile High-Definition Link (MHL), Universal Serial Bus (USB), Display Port (DP), Thunderbolt, a Video Graphics Array (VGA) port, a RGB port, D-subminiature (D-SUB), Digital Visual Interface (DVI), Bluetooth, Zigbee, wired/wireless Local Area Network (LAN), Wide Area Network (WAN), Ethernet, IEEE 1394, Audio Engineering Society/European Broadcasting Union (AES/EBU), Optical, Coaxial, and the like.

The display 160 is an element for displaying a captured image obtained through at least one sensor 130 or displaying at least one function in relation to a predetermined task. The display 160 may be implemented as a display module including a self-emitting element, or a display module including a non-self-emitting element and a backlight. Additionally, the display 160 may be implemented as an LFD display according to the above descriptions. For example, the display 160 may be implemented as various types of displays such as a liquid crystal display (LCD), an organic light emitting diode (OLED) display, a light emitting diode (LED), a micro LED, a Mini LED, a plasma display panel (PDP), a quantum dot (QD) display, a quantum dot light-emitting diode (QLED), and the like. In the display 160, driving circuitry implementable in the form of an a-si TFT, a low temperature poly silicon (LTPS) TFT, an organic TFT (OTFT) and the like, a backlight unit and the like may be included together.

The input/output interface 170 may be any one of a High-Definition Multimedia Interface (HDMI), a Mobile High-Definition Link (MHL), a Universal Serial Bus (USB), a Display Port (DP), a Thunderbolt, a Video Graphics Array (VGA) port, a RGB port, a D-subminiature (D-SUB), and a Digital Visual Interface, (DVI). The input/output interface 170 may input/output at least one of an audio signal and a video signal. Depending on embodiments, the input/output interface 170 may include a port inputting/outputting an audio signal only and a port inputting/outputting a video signal only as an individual port, or be implemented as one port inputting/outputting both of an audio signal and a video signal.

The robot 100 may transmit at least one of an audio signal and a video signal to an external apparatus (e.g., another electronic apparatus or another robot) through the input-output interface 170. Specifically, an output port included in the input/output interface 170 may be connected to an external apparatus, and the robot 100 may transmit at least one of an audio signal and a video signal to the external apparatus through the output port.

The speaker 180 may convert a digital sound signal processed in the processor 120 into an analogue sound signal and amplify and output the same. For example, the speaker 180 may include at least one speaker unit, a D/A converter, an audio amplifier, and the like that may output at least one channel. For example, the processor 120 may output various types of notifications, messages, information and the like in relation to a feedback through the speaker 180.

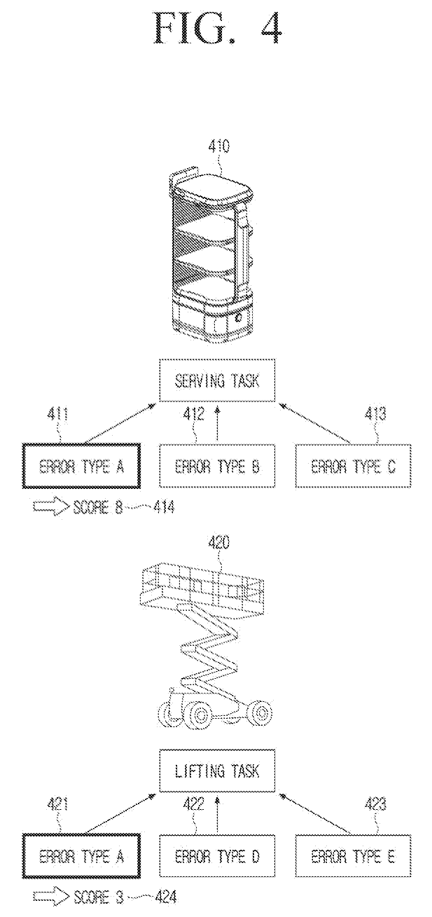

FIG. 4 is a view provided to explain a process of identifying score information corresponding to a type of an error of each predetermined task of a robot, according to one or more embodiments.

According to one or more embodiments, the robot 100 may identify information corresponding to a predetermined task of the robot 100, stored in the memory 110. The robot 100 may identify a task for the robot 100 to perform, for example in a manufacturing operation or according to user settings.

According to one or more embodiments, the robot 100 may store score information corresponding to a type of an error of each predetermined task in the memory 110, and identify the same. The score information may include a score value in which a degree of the effect of a type of each error on a predetermined task is quantified. The score information corresponding to a type of an error may be a predetermined value, and may be set in a manufacturing stage or set by the user directly.

For example, in the case of a robot performing a cleaning task, since a surrounding obstacle may be sensed through a LiDAR sensor, a LiDAR sensor error type may include a highest score value. On the other hand, in the case of an error type of displaying a task performance degree, since an effect on a predetermined task (e.g., a cleaning task) is minor, the error type may include a lowest score value.

The score information corresponding to a type of an error of each task may be score information in the form of a lookup table. The lookup table may include score information corresponding to a plurality of types of errors in relation to at least one function of each predetermined task and corresponding to a type of an error of each task.

According to one or more embodiments, as for the robot 100, score information corresponding to an identical error type of each predetermined task may differ. In one example, in the case of a robot performing a task A and a robot performing a task B, an identical first error type in relation to an identical function may be identified. However, despite an identical error type, an effect on the performance of a task may differ depending on a predetermined task (e.g., a task A or a task B). In this case, a score value corresponding to the identified first error type of a robot performing the task A may differ from a score value corresponding to the first error type of the robot performing the task B.

Referring to FIG. 4, a serving robot 410 performing a serving task (or a task A) may identify a travel error type (or an error type A) 411, an error type B 412, and an error type C 413 in relation to at least one function. An industrial robot 420 performing a lifting task (or a task B) may identify an error type A 421, an error type D 422, and an error type E 423 in relation to at least one function.

In one example, since the robot 410 performing the task A performs a serving task by controlling a travel speed, the score information corresponding to the identified error type A 411 may include a score value 8 414. On the other hand, since as for the robot 420 performing the task B, the task of loading and lifting items is a main one, the score information corresponding to the identified error type A may include a score value 3 424.

Despite having identical error types, the score information corresponding to the error types may differ depending on the predetermined tasks.

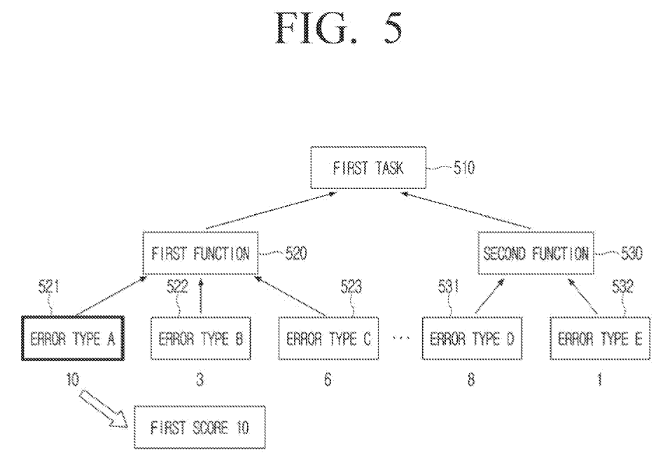

FIG. 5 is a view provided to explain a process of identifying a score corresponding to a performable degree of a predetermined task of a robot, according to one or more embodiments.

According to one or more embodiments, the robot 100 may identify a first score corresponding to a performable degree of a predetermined task based on score information corresponding to an identified error type. In one example, the first score may be a value identical with a score value included in score information corresponding to an error type. In one example, a maximum of the first score may be 10. However, a maximum of a score corresponding to a performable degree of a predetermined task may not be limited thereto, and may be set differently in a manufacturing stage of a robot 100 or according to user settings.

Referring to FIG. 4, in the case of a serving robot 410 performing a task A, the first score based on an error type A may be 8. For example, in the case of an industrial robot 420 performing a task B, the first score based on the error type A may be 3.

Referring to FIG. 5, the robot 100 may monitor a first function 520 and a second function 530 for performing a first predetermined task 510. When identifying that an error occurs in the first function 520, the robot 100 may identify an error type A 521, an error type B 522, and an error type C 523 based on the error having occurred. Similarly, the robot 100 may identify an error type D 531 and an error type E 532 based on an error that occurs in a second function 530.

The robot 100 may identify a score value corresponding to each error type based on a lookup table including score information corresponding to an error type of each task, which is described with reference to FIG. 4. In one example, with regard to the robot 100, the first score may be 10 in a case where an error having occurred is the error type A. In another example, with regard to the robot 100, the first score may be 6 in a case where an error having occurred is the error type C.

According to one or more embodiments, the robot 100 may modify the at least one function based on the first score. Specifically, the robot 100 may control a function in which an error occurs. For example, in a case where a sensing data processing error type in a surrounding obstacle sensing function is identified, a sensing range of a surrounding obstacle may be adjusted. Additionally, the robot 100 may control another function in which an error does not occur. For example, in the case where a LiDAR sensor error type in the surrounding obstacle sensing function is identified, a travel function for reducing a travel speed may be modified.

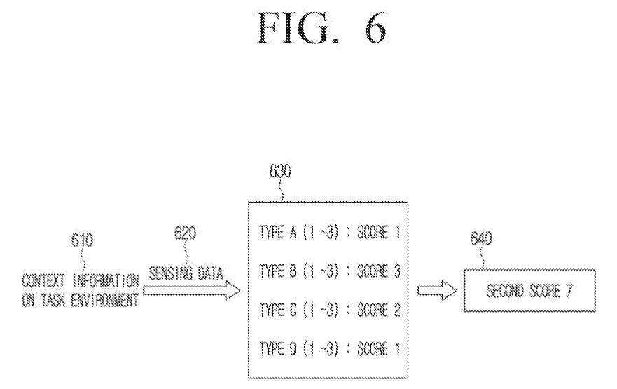

FIG. 6 is a view provided to explain a process of identifying a score corresponding to context information on a task environment of a robot, according to one or more embodiments.

According to one or more embodiments, the robot 100 may obtain context information on a task environment of a robot 100 based on sensing data obtained from at least one sensor.

According to one example, in the case where the robot 100 controls at least one function due to the occurrence of an error in the at least one function, a degree (level) of controlling the at least one function may differ depending on context information on a task environment of the robot 100. For example, when at least one function is controlled due to the occurrence of an error in the at least one function of a cleaning robot, the at least one function may be stopped immediately rather than being modified if a large number of dynamic obstacles are around the robot. For example, in the case of a serving robot, when items loaded on the main body of the serving robot are loaded outside a predetermined range, at least one function may be stopped immediately rather than being modified. In the process of controlling at least one function of the robot 100, context information on a task environment of the robot 100 may be considered as well as a performable degree of a predetermined task, as described above.

The context information on a task environment may include subsidiary context information on a task environment of the robot 100 for performing a predetermined task.

In one example, the context information on a task environment may include information (a type A) as to whether a dynamic obstacle is around the robot 100. The dynamic obstacle may include a dynamic object such as a human, another robot and the like. The robot 100 may identify a dynamic obstacle around the robot 100 based on sensing data sensed from at least one sensor.

In one example, the context information on a task environment may include information (or a type B) on a degree of loaded objects loaded on the main body of the robot 100. The robot 100 may identify whether there are loaded objects and identify a degree to which objects are loaded through at least one sensor.

In one example, the context information on a task environment may include information (or a type C) on a margin distance from an object around the robot 100. The robot 100 may identify information on a distance from a surrounding object through a LiDAR sensor or a depth camera.

In one example, the context information on a task environment may include information (or a type D) on a surface traveled by the robot 100. The robot 100 may identify a friction level of a travel surface through at least one sensor.

The context information on a task environment may not be limited to the above-described examples, and may further include an additional type. Types included in the context information on a task environment may be set in a manufacturing process or directly by the user. However, in the disclosure, description is provided for convenience of description under the assumption that four types are included in the context information on a task environment.

According to one or more embodiments, the robot 100 may identify a second score corresponding to the context information on a task environment of the robot 100 based on the types A-D. The second score may be a score based on an addition of all scores in relation to each type included in the context information.

In one example, a minimum and a maximum of each type included in the context information may be 1 and 3, but not limited thereto. For example, in the case where there are a large number of surrounding dynamic obstacles, a maximum and a minimum may be 3 and 1. For example, in the case where there are a large number of loaded objects, a maximum and a minimum may be 3 and 1.

In one example, since a total of four types is included in the context information, a minimum and a maximum of the second score may be 3 and 12.

Referring to FIG. 6, the robot 100 may identify a second score 640 corresponding to context information 610 on a task environment of the robot 100 based on sensing data 620 sensed from at least one sensor. The context information on a task environment may include types A-D 630.

In one example, in the case where a small number of dynamic obstacles are around the robot 100, a friction level of a travel surface is high, a margin distance is approximate to an average value, and there are a large number of loaded objects, the robot 100 may identify a score of 1 corresponding to the type A, a score of 3 corresponding to the type B, a score of 2 corresponding to the type C and a score of 1 corresponding to the type D through at least one sensor.

In one example, the robot 100 may identify the second score 640 of 7 that is a total of the score corresponding to the type A to the score corresponding to the type D.

According to one or more embodiments, the robot 100 may degradation-control at least one function based on a performable degree of a predetermined task and context information on a task environment. Specifically, the robot 100 may control at least one function based on a first score and a second score.

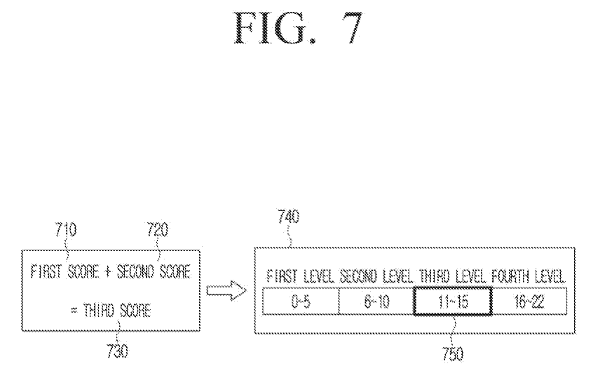

FIG. 7 is a view provided to explain a process of identifying a plurality of control levels corresponding to at least one function of a robot, according to one or more embodiments.

According to one or more embodiments, the robot 100 may identify one of the plurality of control levels corresponding to at least one function based on a first score and a second score. The robot 100 may identify a third score that is a total of the first score and the second score. In one example, referring to FIGS. 5 and 6, a maximum of the third score may be 22.

The plurality of control levels may include at least one of function maintenance (or a first level), limited function maintenance (or a second level), a function stop after completion of a current task (or a third level), and an immediate function stop (or a fourth level) to modify operation of at least one function of the robot 100. The robot 100 may identify one of the plurality of control levels based on a third score.

In one example, the first level may be scores of 0-5, the second level may be scores of 6-10, the third level may be scores of 11-15, and the fourth level may be scores of 16-22. However, the score range of each level may not be limited thereto, and may be set to another range.

Referring to FIG. 7, the robot 100 may identify one of the plurality of control levels 740 based on a third score 730 that is a total of a first score 710 and a second score 720. For example, in the case where the first score 710 is 7 and the second score 720 is 5, the robot 100 may identify a third level 750 based on the third score 730 of 12. In this case, the robot 100 may control the at least one function to a function stop after completion of a current task.

According to one or more embodiments, the robot 100 may provide an alarm notification corresponding to the identified control level. In one example, the robot 100 may provide a different alarm sound that is set in relation to each control level through the speaker 180. In one example, the robot 100 may provide alarm light of a different pattern or different bright set in relation to each control level through at least one sensor.

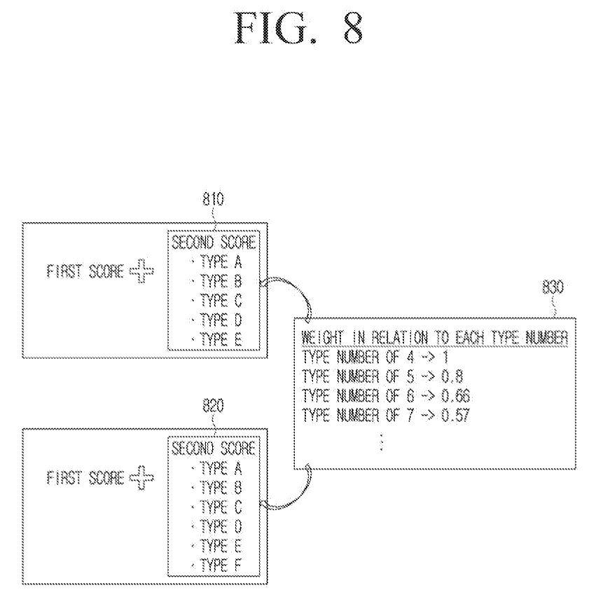

FIG. 8 is a view provided to explain a process of identifying a first score and a second score based on weighted scores, according to one or more embodiments.

According to one or more embodiments, the robot 100 may identify a weight to be applied to each of the first score and the second score based on a number of types of context information.

According to one example, the robot 100 may control at least one function based on an entire score (or a third score) that is a total of the first score and the second score. However, the second score may be identified as a score that is a total of scores corresponding each type of context information, while the first score may be identified based on score information corresponding to an error type stored in the memory 110. In the above-described embodiment, description is provided under the assumption that the number of types of context information is 4, but in the case where the number of types of the context information is greater than 4, the third score may exceed a maximum score of 22.

According to one example, in the case where a number of types of context information on a task environment of the robot 100 exceeds 4 and the second score is identified as being high, there may be a case where the robot 100 immediately stops at least one function, although the first score corresponding to a performable degree of a predetermined task is a low score less than 5. To solve such a problem, the robot 100 may apply a different weight to the first score and/or the second score based on a number of types of context information.

According to one or more embodiments, the robot 100 may degradation–control at least one function based on the first score and the second score to which the identified weight is applied.

Referring to FIG. 8, the robot 100 may identify a weight to be applied to a second score based on a number of types of predetermined context information. In the case where the number of types of the context information is 4, since a maximum score of the second score is 12, a weight in relation to each number of types of the context information may be identified with reference to the score of 12.

For example, when the number of types of the context information is 5 (810), since a maximum score of the second score is 15 in the case where a maximum score in relation to each type is 3, the weight to be applied to the second score may be identified as 0.8 with reference to the score of 12. For example, when the number of types of the context information is 6 (820), since a maximum score of the second score is 18 in the case where a maximum score in relation to each type is 3, the weight to be applied to the second score may be identified as 0.66 with reference to the score 12.

According to one example, a weight 830 to be applied in relation to each number of types of context information may be identified and stored in the memory 110.

FIG. 8 shows the process of identifying a third score only by identifying a weight to be applied to a second score, but depending on a number of types of context information, a different weight may be applied to the first score and the second score. In addition, a maximum score in relation to each type included in context information may be adjusted.

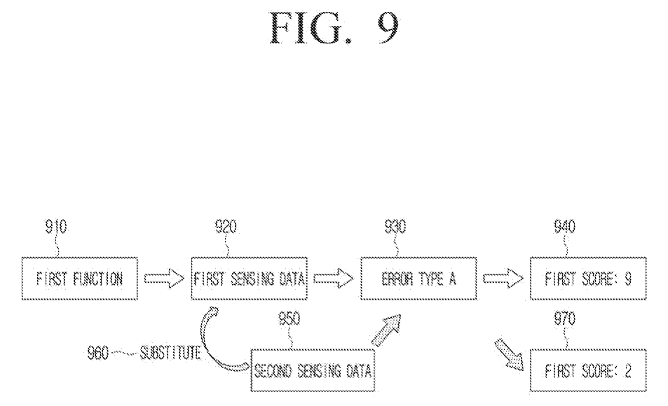

FIG. 9 is a view provided to explain a process of identifying a performable degree of a predetermined task based on alternative data of a robot, according to one or more embodiments.

According to one or more embodiments, the robot 100 may identify second sensing data to substitute for first sensing data of a sensor to which an error occurs based on a type of an error. The first sensing data and the second sensing data may be data that is sensed through sensors different from each other. For example, while the first sensing data may be data sensed through a LiDAR sensor, the second sensing data may be data sensed through a depth camera.

According to one example, in the case where an error type corresponding to a first sensor in a surrounding obstacle sensing function is identified, the robot 100 may not perform a predetermined task due to the error type, as intended previously. In this case, the robot 100 may identify a first score of a high score based on the error type.

However, in the case where second sensing data of a second sensor may substitute for the first sensing data of the first sensor despite the occurrence of an error in the first sensor, the robot 100 may perform the predetermined task as intended previously. In this case, the robot 100 may identify a first score of a low score based on the error type.

According to one or more embodiments, the robot 100 may identify a performable degree of a predetermined task by substituting the first sensing data with the second sensing data.

Referring to FIG. 9, the robot 100 may implement a first function 910 based on first sensing data 920 of a first sensor. In the case where an error occurs to the first sensor, the robot 100 may identify an error type A 930 based on the first sensing data 920 of the first sensor. The robot 100 may identify a first score (e.g., a score of 9) 940 based on the error type A 930.

However, in the case where the first function 910 is implementable based on second sensing data 950 of a second sensor, the robot 100 may identify a first score (e.g., a score of 2) 970 by substituting 960 the first sensing data 920 with the second sensing data 950.

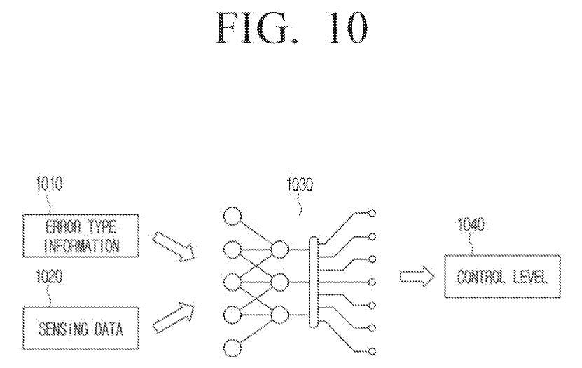

FIG. 10 is a view provided to explain a process of controlling at least one function based on an artificial intelligence model of a robot, according to one or more embodiments.

According to one or more embodiments, the robot 100 may identify one of a plurality of control levels corresponding to at least one function by inputting type information of an error and sensing data obtained from at least one sensor to an artificial intelligence model.

The type information of an error may include function information corresponding to a type of an error, a type of an error, a sensed data value, information on results of a self-diagnosis and the like. The type information of an error may be information for identifying a predetermined task and a type of an error.

The artificial intelligence model may denote a model outputting an output value by inputting a specific input value to a specific function based on trained data. Herein, the artificial intelligence model may be a model trained to identify a performable degree of a predetermined task and context information on a task environment based on type information of an error and sensing data. The artificial intelligence model may be referred to as a neural network model, a deep learning model, a generative artificial intelligence model and the like in various ways, but in the disclosure, referred to an artificial intelligence model collectively.

Herein, training an artificial intelligence model may denote training a basic artificial intelligence model (e.g., an artificial intelligence model including any random parameters) by using a large number of training data through a learning algorithm, to generate previously-defined operational regulations or artificial intelligence models that are set to achieve desired features (or purposes). Such training may be performed through a separate server and/or system, but not limited thereto, and may also be performed by a cooking apparatus. Examples of the learning algorithm may include supervised learning, unsupervised learning, semi-supervised learning or reinforcement learning, but not limited thereto.

Herein, the artificial intelligence model, for example, may be implemented as a convolutional neural network (CNN), a recurrent neural network (RNN), a restricted boltzmann machine (RBM), a deep belief network (DBN), a bidirectional recurrent deep neural network (BRDNN) or a Deep Q-Network and the like, but not limited thereto.

According to one or more embodiments, the robot 100 may degradation-control at least one function based on an identified control level. Since a control method of at least one function is described with reference to the above embodiments, detailed description in relation to this is avoided.

Referring to FIG. 10, the robot 100 may identify one of a plurality of control levels 1040 corresponding to at least one function by inputting error type information 1010 and sensing data 1020 to an artificial intelligence model 1030. In the case where a control level (e.g., a first level to a fourth level) is identified through the artificial intelligence model 1030, the robot 100 may degradation-control the at least one function based on the identified control level.

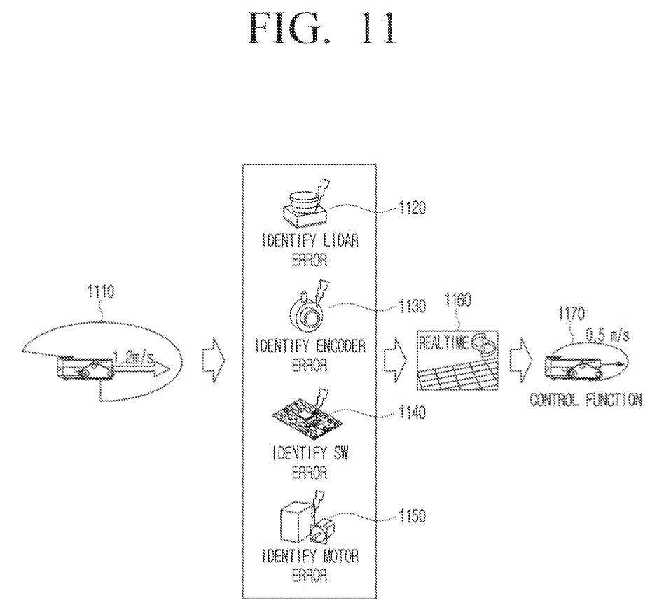

FIG. 11 is a view provided to explain a process of controlling at least one function of a robot, according to one or more embodiments.

Referring to FIG. 11, the robot 100 may be a robot 1110 traveling at 1.2 m/s in an obstacle sensing range of 10 m. In one example, the robot 100 may identify at least one of a LiDAR error 1120, an encoder error 1130, a software error 1140, and a motor error 1150 in at least one function. The robot 100 may identify a type of an error based on each identified error. The robot 100 may identify a performable degree of a predetermined task and context information on a task environment based on the type of the error in real time 1160. The robot 100 may control 1170 a function in relation to each identified error.

In one example, when identifying the LiDAR error 1120, the robot 100 may perform operations of reducing an obstacle sensing region for reducing a computation amount, reducing a travel speed, and notifying an alarm. In one example, when identifying the encoder error 1130, the robot 100 may further perform an operation of replacing sensing data through a LiDAR sensor. In one example, when identifying the motor error 1150, the robot 100 may perform an operation of reducing a motor control cycle.

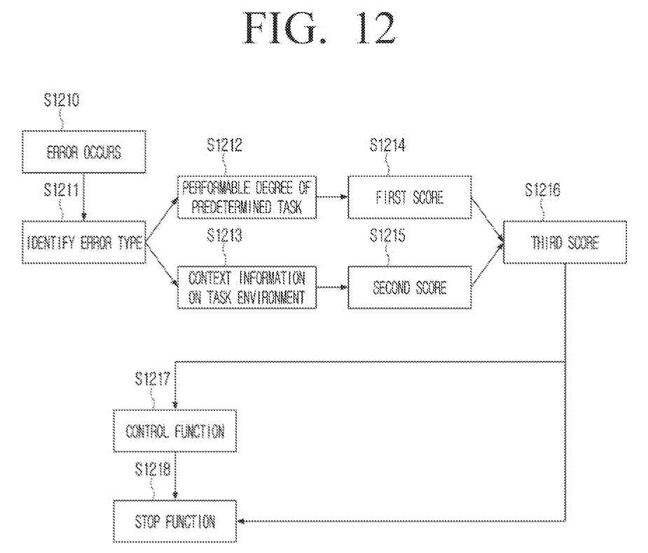

FIG. 12 is a flowchart provided to explain an entire operation process of a robot, according to one or more embodiments.

Referring to FIG. 12, the robot 100 may identify an error occurring in at least one function in operation S1210.

In operation S1211, when identifying that an error occurs in at least one function, the robot 100 may identify a type of the error.

In operation S1212, the robot 100 may identify a performable degree of a predetermined task, resulting from the error, based on the type of the error.

In operation S1213, the robot 100 may obtain context information on a task environment of the robot 100 based on sensing data obtained from at least one sensor.

In operation S1214, the robot 100 may identify a first score corresponding to the performable degree of a predetermined task.

In operation S1215, the robot 100 may identify a second score corresponding to the context information.

In operation S1216, the robot 100 may identify a third score based on the first score and the second score.

In operation S1217, the robot 100 may control the function based on the third score.

In operation S1218, the robot 100 may stop the function immediately based on the third score.

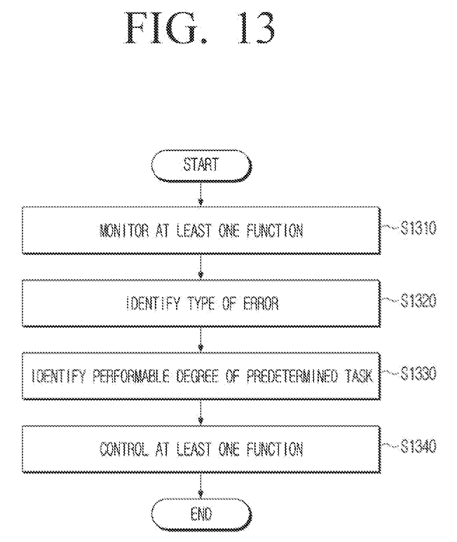

FIG. 13 is a flowchart provided to explain an operation of a robot, according to one or more embodiments.

Referring to FIG. 13, in operation S1310, the robot 100 may monitor at least one function of the robot 100 for performing a predetermined task.

In operation S1320, when identifying that an error occurs in the at least one function, the robot 100 may identify a type of the error.

In operation S1330, the robot 100 may identify a performable degree of a predetermined task, resulting from the error, based on the type of the error.

In operation S1340, the robot 100 may degradation-control the at least one function based on the performable degree of a predetermined task.

Since a method of identifying the type of the error, identifying the performable degree of a predetermined task, and controlling the at least one function is described in detail with reference to the above-described embodiments, repetitive description in relation to this is avoided.

The control method described with reference to FIG. 13 may be performed by the robot 100 having the configuration of FIG. 2 described above, but not limited thereto, and may also be performed by a robot having various configurations.

One or more embodiments described above may be implemented solely, and at least one of the embodiments may be combined partially or entirely and implemented together in one device.

According to the one or more embodiments described above, in the case where an error occurs in at least one function, the robot may modify its control of the at least one function rather than stopping the at least one function immediately, to increase the productivity of the robot.

Among the one or more embodiments described above, an embodiment may be solely applied to a product, but at least part of the particulars of the embodiment may be combined with another embodiment and implemented together with another embodiment.

The one or more embodiments described above may be implemented with software including instructions stored in a storage medium readable by a machine (e.g., a computer). The machine, as a device capable of calling the stored instructions from the storage media and operating according to the called instructions, may include an electronic apparatus (e.g., a robot 100) according to the disclosed embodiments. Based on instructions executed by a processor, the processor may perform functions corresponding to the instructions directly or by using other elements under the control of the processor. The instructions may include a code generated or executed by a compiler or an interpreter. The machine-readable storage medium may be provided in the form of a non-transitory computer readable storage medium. Herein, the term “non-transitory” only means that the storage medium includes no signal and is tangible, while the term does distinguish semi-permanent or temporary storage of data in the storage medium.

Additionally, the method according to the one or more embodiments described above may be provided in a computer program product.

Specifically, a non-transitory readable storage medium or a computer program product storing computer instructions for performing the operation of monitoring at least one function of a robot for performing a predetermined task, and based on identifying that an error occurs in the at least one function, the operation of identifying a type of the error, the operation of identifying a performable degree of the predetermined task resulting from the error based on the type of the error, and the operation of controlling the at least one function based on the performable degree of the predetermined task may be provided.

The computer program product may be distributed in the form of a machine-readable storage medium (e.g., compact disc read only memory (CD-ROM)) or distributed (e.g., downloaded or uploaded) online through an application store (e.g., PlayStoreTM) or directly between two user devices (e.g., smartphones). In the case of an online distribution, at least part of the computer program product (e.g., a downloadable app) may be stored at least temporarily, or generated temporarily in a storage medium such as a server of a manufacturer, a server of an application store, or memory of a relay server.

Further, computer instructions or programs for performing a control method of a robot and the like according to various embodiment described above may be stored in a non-transitory computer-readable medium. When the computer instructions stored in such a non-transitory computer-readable medium are executed by the processor of a specific device, the specific device is to perform processing operations in the device according to the one or more embodiments described above. The non-transitory computer-readable medium denotes a medium that stores data semi-permanently and is readable by a machine, rather than a medium such as a register, cache, memory and the like that store data temporarily. Specific examples of the non-transitory computer-readable medium may include a CD, a DVD, a hard disc, a blue-ray disc, a USB, a memory card, ROM and the like.

While example embodiments of the present disclosure are illustrated and described above, embodiments are not limited to the embodiments set forth herein, and certainly, various modifications thereof may be made by one having ordinary skill in the art to which the present disclosure pertains, without departing from the scope of the disclosure claimed in the section of claims, and are not to be understood as separating from the technical spirit or prospect of the disclosure.

What is claimed is:

1. A robot comprising:
memory storing instructions; and
one or more processors comprising processing circuitry,
wherein the instructions, when executed by the one or more processors individually or collectively, cause the robot to:
monitor at least one function of the robot, wherein the at least one function is associated with performing a predetermined task;
based on identifying that an error related to the at least one function has occurred, identify a type of the error;
identify a degree to which the robot is able to perform the predetermined task after occurrence of the error, based on the type of the error; and
modify the at least one function based on the degree to which the robot is able to perform the predetermined task.

2. The robot of claim 1, wherein the memory further stores score information corresponding a type of an error related to each of a plurality of tasks including the predetermined task, and
wherein the instructions, when executed by the one or more processors individually or collectively, further cause the robot to:
identify a score corresponding to the degree to which the robot is able to perform the predetermined task based on the score information; and
modify the at least one function based on the score.

3. The robot of claim 1, further comprising:
at least one sensor,
wherein the instructions, when executed by the one or more processors individually or collectively, further cause the robot to:
obtain context information on a task environment of the robot based on sensing data obtained from the at least one sensor; and
modify the at least one function based on the context information and the degree to which the robot is able to perform the predetermined task.

4. The robot of claim 3, wherein the memory further stores first score information corresponding to a type of an error related to each of a plurality of tasks including the predetermined task and second score information related to each of a plurality of task environments, and
wherein the instructions, when executed by the one or more processors individually or collectively, further cause the robot to:
identify, based on the first and the second score information, a first score corresponding to the degree to which the robot is able to perform the predetermined task;
identify, based on the first and the second score information, a second score corresponding to the context information; and
modify the at least one function based on the first score and the second score.

5. The robot of claim 4, wherein the instructions, when executed by the one or more processors individually or collectively, further cause the robot to:
identify one of a plurality of control levels corresponding to the at least one function based on the first score and the second score; and
modify the at least one function based on the identified control level.

6. The robot of claim 5, wherein the plurality of control levels comprises at least one of function maintenance, limited function maintenance, function stop after completion of a current task, and immediate function stop.

7. The robot of claim 5, wherein the instructions, when executed by the one or more processors individually or collectively, further cause the robot to:
provide an alarm notification corresponding to the identified control level.

8. The robot of claim 5, wherein the instructions, when executed by the one or more processors individually or collectively, further cause the robot to:
identify a weight to be applied to each of the first score and the second score based on a number of types of the context information; and
modify the at least one function based on the first score and the second score to which the identified weight is applied.

9. The robot of claim 5, wherein the instructions, when executed by the one or more processors individually or collectively, further cause the robot to:
identify, based on a type of the error, second sensing data to substitute for first sensing data of a sensor to which the error occurs among the at least one sensor; and
identify the degree to which the robot is able to perform the predetermined task by substituting the first sensing data with the second sensing data.

10. The robot of claim 1, further comprising:
at least one sensor,
wherein the instructions, when executed by the one or more processors individually or collectively, further cause the robot to:
identify one of a plurality of control levels corresponding to the at least one function by inputting, to an artificial intelligence model, type information of the error and sensing data obtained from the at least one sensor; and
modify the at least one function based on the identified control level.

11. A method of controlling a robot, the method comprising:
monitoring at least one function of the robot, wherein the at least one function is associated with performing a predetermined task;
based on identifying that an error related to the at least one function has occurred, identifying a type of the error;
identifying a degree to which the robot is able to perform the predetermined task after occurrence of the error, based on the type of the error; and
modifying the at least one function based on the degree to which the robot is able to perform the predetermined task.

12. The method of claim 11, wherein the modifying the at least one function comprises:
identifying a score corresponding to the degree to which the robot is able to perform the predetermined task based on score information corresponding to a type of an error related to each of a plurality of tasks including the predetermined task; and
modifying the at least one function based on the score.

13. The method of claim 11, wherein the modifying the at least one function comprises:
obtaining context information on a task environment of the robot based on sensing data obtained from at least one sensor of the robot; and
modifying the at least one function based on the context information and the degree to which the robot is able to perform the predetermined task.

14. The method of claim 13, wherein the modifying the at least one function further comprises:
identifying, based on score information corresponding to a type of an error related to each of a plurality of tasks including the predetermined task, a first score corresponding to the degree to which the robot is able to perform the predetermined task;
identifying, based on score information of each of a plurality of task environments, a second score corresponding to the context information; and
modifying the at least one function based on the first score and the second score.

15. The method of claim 14, wherein the modifying the at least one function further comprises:
identifying one of a plurality of control levels corresponding to the at least one function based on the first score and the second score; and
modifying the at least one function based on the identified control level.

16. A non-transitory computer readable storage medium having instructions stored therein, which when executed by one or more processors cause the one or more processors to execute a method of controlling a robot, the method comprising:
monitoring at least one function of the robot, wherein the at least one function is associated with performing a predetermined task;
based on identifying that an error related to the at least one function has occurred, identifying a type of the error;
identifying a degree to which the robot is able to perform the predetermined task after occurrence of the error, based on the type of the error; and
modifying the at least one function based on the degree to which the robot is able to perform the predetermined task.

17. The non-transitory computer readable storage medium of claim 16, wherein the modifying the at least one function comprises:
identifying a score corresponding to the degree to which the robot is able to perform the predetermined task based on score information corresponding to a type of an error related to each of a plurality of tasks including the predetermined task; and
modifying the at least one function based on the score.

18. The non-transitory computer readable storage medium of claim 16, wherein the modifying the at least one function comprises:
obtaining context information on a task environment of the robot based on sensing data obtained from at least one sensor of the robot; and
modifying the at least one function based on the context information and the degree to which the robot is able to perform the predetermined task.

19. The non-transitory computer readable storage medium of claim 18, wherein the modifying the at least one function further comprises:
identifying, based on score information corresponding to a type of an error related to each of a plurality of tasks including the predetermined task, a first score corresponding to the degree to which the robot is able to perform the predetermined task;
identifying, based on score information of each of a plurality of task environments, a second score corresponding to the context information; and
modifying the at least one function based on the first score and the second score.

20. The non-transitory computer readable storage medium of claim 19, wherein the modifying the at least one function further comprises:
identifying one of a plurality of control levels corresponding to the at least one function based on the first score and the second score; and
modifying the at least one function based on the identified control level.
